(19) United States
(12) Patent Application Publication
(10) Pub. No.: US 2006/0069563 A1
(43) Pub. Date: Mar. 30, 2006

(54) Constrained mixed-initiative in a voice-activated command system

(75) Inventors: Yun-Cheng Ju, Bellevue, WA (US); David G. Ollason, Seattle, WA (US); Siddharth Bhatia, Kirkland, WA (US)

Correspondence Address: WESTMAN CHAMPLIN (MICROSOFT CORPORATION), SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/939,254

(22) Filed: Sep. 10, 2004

(51) Int. Cl. G10L 15/04

(52) U.S. Cl. 704/252

(57) ABSTRACT

A method of allowing a user to provide constrained, mixed-initiative utterances in order to improve accuracy and avoid disambiguation dialogs when recognition of a user's audible input would otherwise render a number of possible selections from the database or list is provided. A grammar is adapted to include additional information associated with at least some of the entries. The additional information forms part of the information conveyed by the use in the constrained, mixed-initiative utterance.

### BACKGROUND OF THE INVENTION

The present invention generally pertains to voice-activated command systems. More specifically, the present invention pertains to methods and an apparatus for improving accuracy and speeding up confirmation of selections in voice-activated command systems.

Voice-activated command systems are being used with increasing frequency as a user interface for many applications. Voice-activated command systems are advantageous because they do not require the user to manipulate an input device such as a keyboard. As such, voice-activated command systems can be used with small computer devices such as portable handheld devices, cell phones as well as systems such as name dialers where a simple phone allows the user to input a desired name of a person the user would like to talk to.

However, a significant problem with voice-activated command systems includes differentiating between identical or similar sounding voice requests. In voice dialing applications by way of example, names with similar pronunciations, such as homonyms or even identically spelled names, present unique challenges. These “name collisions” are problematic in voice-dialing, not only in speech recognition but also in name confirmation. In fact, some research has shown that name collision is one of the most confusing (for users) and error prone (for users and for voice-dialing systems) areas in the name confirmation process.

The present invention provides solutions to one or more of the above-described problems and/or provides other advantages over the prior art.

### SUMMARY OF THE INVENTION

An aspect of the present invention includes a method of allowing a user to provide constrained, mixed-initiative utterances in order to improve accuracy and avoid disambiguation dialogs when recognition of a user's audible input would otherwise render a number of possible selections from the database or list. This technique utilizes a grammar adapted to include additional information associated with at least some of the entries. The additional information forms part of the information conveyed by the use in the mixed-initiative utterance. By including the additional information, accuracy is improved due to the longer acoustic signature of the user's utterance, and disambiguation dialogs are avoided because recognition of many users' utterances will only correspond to one of the entries in the grammar, and thus, one of the entries in the database or list.

Other features and benefits that characterize embodiments of the present invention will be apparent upon reading the following detailed description and review of the associated drawings.

### BRIEF DESCRIPTION OF THE DRAWINGS

FIG. 1 is a block diagram representation of a general computing environment in which illustrative embodiments of the present invention may be practiced.

FIG. 2 is a schematic block diagram representation of a voice-activated command system.

### DETAILED DESCRIPTION OF ILLUSTRATIVE EMBODIMENTS

Various aspects of the present invention pertain to methods and apparatus for ascertaining the proper selection or command provided by a user in a voice-activated command system. Examples of well-known computing systems, environments, and/or configurations that may be suitable for use with the invention include, but are not limited to, personal computers, server computers, hand-held or laptop devices, multiprocessor systems, microprocessor-based systems, set top boxes, and other voice-activated command systems such as programmable dialing applications. Embodiments of the present invention can be implemented in association with a call routing system, wherein a caller identifies with whom they would like to communicate and the call is routed accordingly. Embodiments can also be implemented in association with a voice message system, wherein a caller identifies for whom a message is to be left and the call or message is sorted and routed accordingly. Embodiments can also be implemented in association with a combination of call routing and voice message systems. It should also be noted that the present invention is not limited to call routing and voice message systems. These are simply examples of systems within which embodiments of the present invention can be implemented. In other embodiments, the present invention is implemented in a voice-activated command system such as obtaining a specific selection from a list of items. For example, the present invention can be implemented so as to obtain information (address, telephone number, etc.) of a person in a “Contacts” list on a computing device.

Prior to discussing embodiments of the present invention in detail, exemplary computing environments within which the embodiments and their associated systems can be implemented will be discussed.

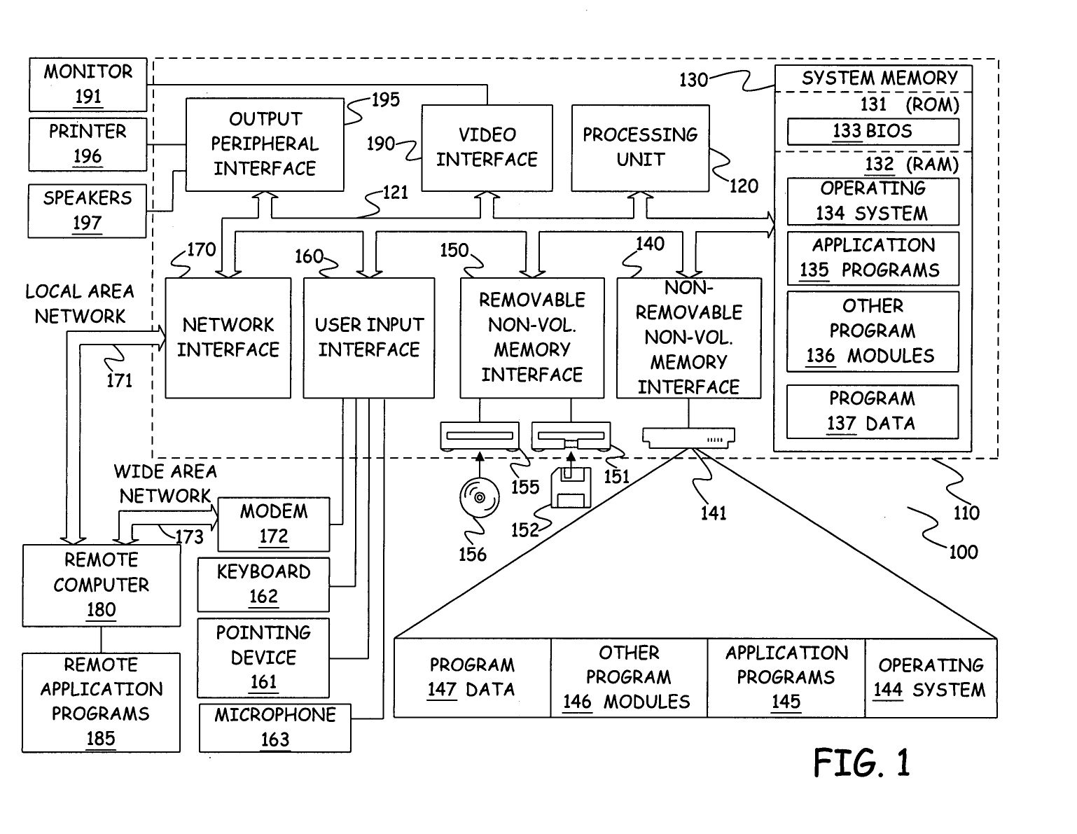

FIG. 1 illustrates an example of a suitable computing environment 100 within which embodiments of the present invention and their associated systems may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of illustrated components.

The present invention is operational with numerous other general purpose or special purpose computing consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Tasks performed by the programs and modules are described below and with the aid of figures. Those skilled in the art can implement the description and figures provided herein as processor executable instructions, which can be written on any form of a computer readable medium.

The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163 (which also represents a telephone), and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

In one exemplary embodiment described below, the present invention is described with reference to a voice-activated command system. However, the illustration of this exemplary embodiment of the invention does not limit the scope of the invention to voice-activated command systems.

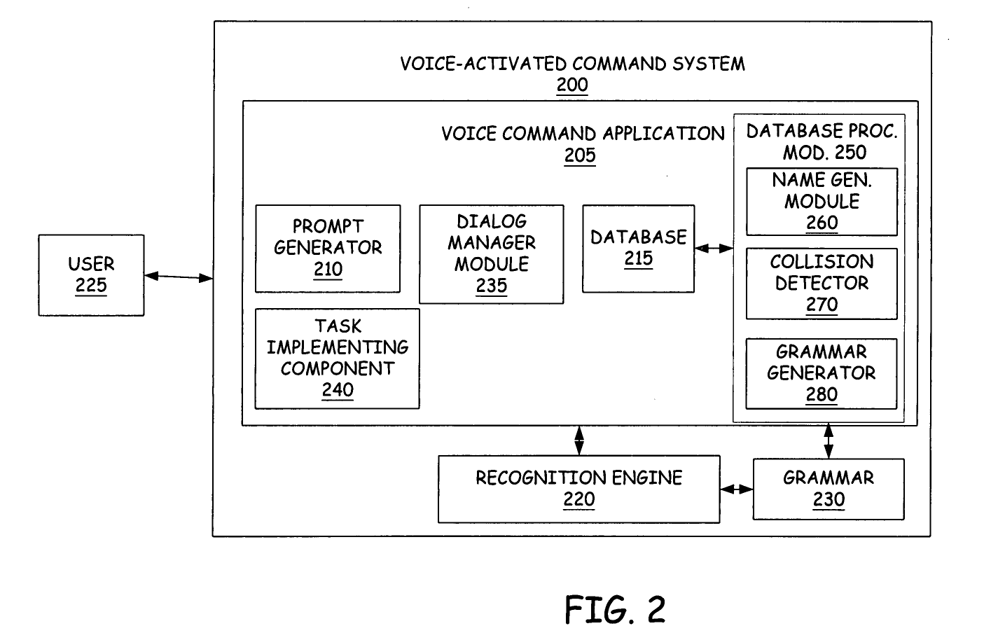

FIG. 2 is a schematic block diagram of a voice-activated command system 200 in accordance with an example embodiment of the present invention. System 200 is accessible by a user 225 to implement a task. System 200 includes a voice command application 205 having access to data typically corresponding to a list or database 215 of choices for user selection. For example, the list of choices can include a list of names of potential call recipients in a voice-dialer application; a list of potential tasks in an automated system such as an automated banking system; a list of items for potential purchase in an automated sales system; a list of items, places or times for potential reservation in an automated reservation system; etc. Many other types of lists of choices can be presented as well.

As in conventional voice-activated command systems, in system 200 the voice command application 205 includes a voice prompt generator 210 configured to generate voice prompts which ask the user to provide input, commonly under the control of a dialog manager module 235. The present invention is primarily directed at voice prompts that do not render items in the list 215, but rather prompt the user with a general question such as “Please provide the name of the person you would like to speak with.” The voice prompts can be generated, for example, using voice talent recordings or text-to-speech (TTS) generation.

System 200 also includes speech recognition engine 220 which is configured to recognize verbal or audible inputs from the user 225 during or in response to the generation of voice prompts by voice prompt generator 210. Speech recognition engine 220 accesses a grammar 230, for example, a context-free grammar, to ascertain what the user has spoken. Typically, grammar 230 is derived from entries in database 215 in a manner described below. An aspect of the present invention includes a method of allowing a user to provide mixed-initiative utterances in order to improve accuracy and avoid disambiguation dialogs when recognition of a user's audible input would otherwise render a number of possible selections from the database or list 215. As will be explained below, this technique utilizes a grammar adapted to include additional information associated with at least some of the entries. The additional information forms part of the information conveyed by the use in the mixed-initiative utterance. By including the additional information, accuracy is improved due to the longer acoustic signature of the user's utterance, and disambiguation dialogs are avoided because recognition of many users' utterances will only correspond to one of the entries in the grammar, and thus, one of the entries in the database or list 215.

In exemplary embodiments, voice command application 205 also includes task implementing module or component 240 configured to carry out the task associated with the user's chosen list item or option. For example, component 240 can embody the function of connecting a caller to an intended call recipient in a voice dialer application implementation of system 200. In another implementation of system 200, component 240 can render a selection from the list, such as rendering a specific person's address, telephone number, etc. stored in a “Contacts” list of a personal information manager program operating on a computer such as a desktop or handheld computer.

It should be noted that application 205, database 215, voice prompt generator 210, speech recognition engine 220, grammar 230, task implementing component 240, and other modules discussed below need not necessarily be implemented within the same computing environment. For example, application 205 and its associated database 215 could be operated from a first computing device that is in communication via a network with a different computing device operating recognition engine 220 and its associated grammar 230. These and other distributed implementations are within the scope of the present invention. Furthermore, the modules described herein and the functions they perform can be combined or separated in other configurations as appreciated by those skilled in the art. As indicated above, grammar 230 is commonly derived from database 215. In many instances, although not necessary in all applications, grammar 230 is generated off-line wherein grammar 230 is routinely updated for changes made in database 215. For example, in a name dialer application, as employees join, leave or move around in a company, their associated phone number or extension thereof is updated. Accordingly, upon routine generation of grammar 230, speech recognition engine 220 will access a current or up-to-date grammar 230 with respect to database 215.

Again, using a name dialer application by example only, database 215 for a company of four employees can be represented as follows:

TABLE 1

| | | Work | |
|---|---|---|---|
| Name | ID | Location | Department |
| Michael Anderson | 11111 | Building 1 | Accounting |
| Michael Anderson | 22222 | Building 2 | Sales |
| Yun-Cheng Ju | 33333 | Building 119 | Research |
| Yun-Chiang Zu | 44444 | Mobile | Service |

In existing name dialer applications, a database processing module similar to module 250 indicated in FIG. 2, will access database 215 in order to generate grammar 230. Database processing module 250 commonly includes a name generating module 260 that accesses database 215 and extracts therefrom entries that can be spoken by a user, herein names of employees, and if desired, an associated identifier that can be used by task implementing component 240 to implement a particular task, for instance, lookup the corresponding employee's telephone number based on the identifier to transfer the call. The table below illustrates a corresponding list of employees with associated employee identifiers generated by name generating module 260.

TABLE 2

| Name to be recognized | ID |
|---|---|
| Michael Anderson | 11111 |
| Michael Anderson | 22222 |
| Yun-Cheng Ju | 33333 |
| Yun-Chiang Zu | 44444 |

Although not illustrated in the above example, name generating module 260 can also generate common nicknames (i.e. alternatives) for entries in the database 215, for instance, “Michael” often has a common nickname “Mike”. Thus, the above list can include two additional entries for each of the employee identifiers having “Mike Anderson”, if desired. In existing systems, a collision detection module similar to module 270 detects entries present in database 215, which have collisions. Information indicative of detected collisions is provided to grammar generator module 280 for inclusion in the grammar. Collisions detected by module 270 can include true collisions (multiple instances of the same spelling) and/or homonyms collisions (multiple spellings, but a common pronunciation) various methods of collision detection can be used. The following table represents information provided to grammar generator module 280:

TABLE 3

| Name to be recognized | SML |
|---|---|
| Michael Anderson | 11111, 22222 |
| Yun-Cheng Ju | 33333 |
| Yun-Chiang Zu | 44444 |

A grammar generator module 280 then generates a suitable grammar in the existing systems such that if a user indicates that he/she would like to speak to “Yun-Cheng Ju” the corresponding output from the speech recognition engine would typically include the text “Yun-Cheng Ju” as well as the corresponding employee identification number “33333”. In addition, other information such as a “confidence level” that the speech recognition engine 220 has properly ascertained if the corresponding output is correct. An example of such an output is provided below using a SML (semantic markup language) format:

### EXAMPLE 1

<SML confidence=“0.735” text=“Yun-Cheng Ju”utteranceConfidence=“0.735”>
33333
</SML>

(In table 3, SML is provided in accordance with this format.)

If however the user desires to speak to “Michael Anderson”, the speech recognition engine will return two corresponding employee identifiers since based on the user's input of “Michael Anderson”, the speech recognition engine cannot differentiate between the “Michael Andersons” in the company. For example, an output in SML would be

### EXAMPLE 2

<SML confidence=“0.825” text=“Michael Anderson”utteranceConfidence=“0.825”>
11111, 22222
</SML>

where, it is noted both identifiers “11111” and “22222” are contained in the output. In such cases, existing systems will use a disambiguation module, not shown, which will query the user for additional information to ascertain which “Michael Anderson” the user would like to speak with. For example, such a module may cause a voice prompt generator to query the user with a question like, “There are two Michael Anderson's in this company. Which Michael Anderson you would like to speak with, Number 1 in Building one or number 2 in Building two?”

An aspect of the present invention minimizes the need for disambiguation logic like that provided above. In particular, database processing module 250 is adapted so as to generate grammar 230 that allows a user to provide additional information regarding a desired entry in database 215, in the form of a constrained, mixed-initiative utterance, wherein the constrained, mixed-initiative utterance causes the speech recognition engine 220 to automatically provide an output that includes disambiguation between like entries in database 215. As is known in the art “mixed-initiative” is when the user in a dialog with a voice-activated command system provides additional information than that queried by the system. As used herein, “constrained, mixed-initiative” is additional information provided by the user that has been previously associated with an entry so as to enable a speech recognizer to directly recognize the intended selection using the additional information and the intended selection.

It is important to realize that disambiguation is not provided from a disambiguation dialog module, but rather, by the use of grammar 230 directly, which has been modified in a manner discussed further below to provide disambiguation.

In the context of the foregoing example, the “work location” of at least some of those entries in database 215 that would have collision problems, and thus require further disambiguation, is included along with the corresponding name to expand the list used for grammar generation. In the table or list below, name generator module 260 has included the additional entries of “Michael Anderson in Building 1”, “Michael Anderson in Building 2”, “Yun-Cheng Ju in Building 119”, and “Yun-Chaing Zu a mobile employee” along with their corresponding employee identifier numbers in addition to other entries without the additional information.

TABLE 4

| Name to be recognized | ID |
|---|---|
| Michael Anderson | 11111 |
| Michael Anderson in building 1 | 11111 |
| Michael Anderson | 22222 |
| Michael Anderson in building 2 | 22222 |
| Yun-Cheng Ju | 33333 |
| Yun-Cheng Ju in building 119 | 33333 |
| Yun-Chiang Zu | 44444 |
| Yun-Chiang Zu, a mobile employee | 44444 |

Stated another way, the grammar formed from the above list would include first portions corresponding to similar utterances (e.g. the two Micheal Andersons, or Yun-Cheng Ju and Yun-Chiang Zu) that therefore require further disambiguation if spoken, and additional second portions comprising one of the first portions and associated additional information (e.g. “Michael Anderson in building 1”). The additional information (e.g. building location, or that one is a mobile employee) being usually different for each of said first portions that correspond to similar utterances if spoken.

As those appreciated by those skilled in the art, other entries with other additional information such as their “department” (as indicated above in the first table) can be included as well or in the alternative to the entries added based upon “work location”. Generally, the “additional information” that is combined with the individual entries to form the expanded list that is used to generate grammar 230 is the same information that the disambiguation dialog module would use if the user only provided an utterance that requires disambiguation.

It is to be understood that if name generator module 260 includes nickname generation, entries according to nickname generation (i.e. alternatives) with the corresponding additional information would also be generated in the list above. Again, by way of example, if “Mike” is used as a common nickname for each “Michael Anderson,” then the list above would also include “Mike Anderson in Building 1” and “Mike Anderson in Building 2”.

Collision detection module 270 receives the list above and merges identical entries together in a manner similar to that described above. Thus, for the list above, based on a criteria of merging identical names, an utterance of only “Michael Anderson” will cause the speech recognition engine to output both of the identifiers “11111” and “22222”. If the user provided such an utterance, dialogue disambiguation module would operate as before to query the user with additional questions in order to perform disambiguation. Table 5 below includes merged names.

TABLE 5

| Name to be recognized | SML |
|---|---|
| Michael Anderson | 11111, 22222 |
| Michael Anderson in building 1 | 11111 |
| Michael Anderson in building 2 | 22222 |
| Yun-Cheng Ju | 33333 |
| Yun-Cheng Ju in building 119 | 33333 |
| Yun-Chiang Zu | 44444 |
| Yun-Chiang Zu a mobile employee | 44444 |

Grammar generator module 260 then operates upon the list identified above so as to generate grammar 230 that includes data to recognize constrained mixed-initiative utterances.

Although it is quite probable that the user would need to know that the database 215 includes entries that require further disambiguation such as between the Michael Andersons indicated above, the user providing the utterance “Michael Anderson in Building 1” would cause the system recognition module 220 to provide an output that corresponds to only one of the Michael Andersons in database 215. In an SML format similar to that described above, such an output can take the following form:

### EXAMPLE 3

<SML confidence=“1.000” text=“Michael Anderson in building 1” utteranceConfidence=“1.000”>
11111
</SML>

Unlike typical mixed-initiative processing, the information in the utterance is not resolved independently in the present invention, which is where “Michael Anderson” of the utterance “Michael Anderson in Building 1” is returned separately from “Building 1”. Resolving portions of the utterance separately can decrease accuracy and cause further confirmation and/or disambiguation routines that need to be employed. For example, for an utterance “Michael Anderson in Building 1,” application logic that processes the utterance portions “Michael Anderson” and “Building 1” separately may believe what was spoken was “Michael Johnson in Building 100” or “Matthew Andres in Building 1” due in part to separate processing of the utterance portions. However, in the present invention, accuracy is improved because recognition is performed upon a longer acoustic utterance against a grammar that contemplates such longer utterances. In a similar manner, the present invention could provide better accuracy between “Yun-Cheng Ju” and “Yun-Chaing Zu” if the user were to utter the phrase “Yun-Cheng Ju in Building 119”. Increased accuracy is provided because the speech recognition engine 220 will more easily differentiate “Yun-Chaing Zu in Building 119” from the other phrases contemplated by the grammar 230 comprising “Yun-Cheng Ju”, “Yun-Chiang Zu”, or “Yun-Chiang Zu a mobile employee”.

Although the present invention has been described with reference to particular embodiments, workers skilled in the art will recognize that changes may be made in form and detail without departing from the spirit and scope of the invention. For instance, although exemplified above with respect to a voice or name dialer application, it should be understood that aspects of the present invention can be incorporated into other applications, and particularly but not limiting, other applications with list of names (persons, places, companies etc.)

For instance, in a system that provides flight arrival informaiton, a grammar associated with recognition of arrival cities can contemplate utterances that also include airline names. For instance, a grammar that otherwise includes “Miami” can also contemplate constrained mixed-initiative utterances of “Miami, via United Airlines”.

Likewise, in another application where a user provides spoken utterances into a personal information manager to access entries in a “Contacts” list, the grammar associated with recognition of the user utterances can contemplate constrained mixed-initiative utterances such as “Eric Moe in Minneapolis” and “Erica Joseph in Seattle” in order to cause immediate disambiguation between the entries, “Eric Moe” and “Erica Joseph”.

What is claimed is:

1. A method of generating a grammar for processing audible input in a voice interactive system, the method comprising:
receiving a list of entries, the entries comprising first portions corresponding to similar utterances if spoken, wherein each entry comprises additional information, said additional information being different for each of said first portions that correspond to similar utterances if spoken; and
forming a grammar based on the list, the grammar comprising the first portions corresponding to similar utterances if spoken and additional second portions comprising one of said first portions and the corresponding additional information.

2. The method of claim 1 wherein forming the grammar comprises:
generating a second list of entries from the first-mentioned list, the second list of entries comprising a set of entries being the first portions by themselves and a second set of entries comprising the first portions and each corresponding additional information;
and wherein forming the grammar comprises forming the grammar from the second list.

3. The method of claim 2 wherein forming the grammar comprises including identifiers in the grammar for each of the first portions and second portions, the identifiers being outputted with recognition of the corresponding first portions and second portions.

4. The method of claim 2 wherein generating the second list comprises generating entries being an alternative for each of a plurality of the first portions in combination with the additional information associated with the corresponding first portion that the alternative is generated from.

5. The method of claim 1 wherein the list comprises a list of names.

6. The method of claim 1 wherein forming the grammar includes generating second portions that comprise an alternative for each of a plurality of the first portions in combination with the additional information associated with the corresponding first portion that the alternative is generated from.

7. A method of processing audible input in a voice interactive system, the method comprising:
receiving audible input from the user; and
performing speech recognition upon the input to generate a speech recognition output, wherein performing speech recognition comprises accessing a grammar adapted to ascertain constrained, mixed initiative utterances.

8. The method of claim 7 wherein the grammar comprises first portions corresponding to similar utterances that would require further disambiguation if spoken, and additional second portions comprising one of said first portions and additional information, said additional information being different for each of said first portions that correspond to similar utterances if spoken.

9. The method of claim 7 wherein the grammar comprises identifiers in the grammar for each of the first portions and second portions, the identifiers being outputted with recognition of the corresponding first portions and second portions.

10. The method of claim 7 wherein the second portions of the grammar comprise an alternative for each of a plurality of the first portions in combination with the additional information associated with the corresponding first portion that the alternative is generated from.

11. The method of claim 7 wherein the grammar is adapted for recognition of names.

12. A voice interactive command system for processing voice commands from a user, the system comprising:
a grammar adapted to ascertain constrained, mixed initiative utterances;
a speech recognition engine for receiving an utterance and operable with the grammar and to provide an output;
a task implementing component operable with the speech recognition engine for performing a task in accordance with the output.

13. The system of claim 12 wherein the grammar comprises first portions corresponding to similar utterances that would require further disambiguation if spoken, and additional second portions comprising one of said first portions and additional information, said additional information being different for each of said first portions that correspond to similar utterances if spoken.

14. The method of claim 13 wherein the second portions of the grammar comprise an alternative for each of a plurality of the first portions in combination with the additional information associated with the corresponding first portion that the alternative is generated from.

15. The method of claim 12 wherein the grammar is adapted for recognition of names.

16. The system of claim 12 wherein the grammar comprises identifiers in the grammar for recognition of the constrained, mixed initiative utterances, the identifiers being outputted with recognition of the constrained, mixed initiative utterances.
